(19) United States
(12) Patent Application Publication
(10) Pub. No.: US 2022/0406542 A1
(43) Pub. Date: Dec. 22, 2022

(54) RELAY CONTROL CIRCUIT AND POWER SUPPLY CIRCUIT

(71) Applicant: SHARP KABUSHIKI KAISHA, Osaka (JP)

(72) Inventor: TAKESHI SHIOMI, Osaka (JP)

(21) Appl. No.: 17/840,086

(22) Filed: Jun. 14, 2022

(30) Foreign Application Priority Data
Jun. 22, 2021 (JP) 2021-103538

(51) Int. Cl. H01H 47/22; H01H 47/00; H01H 47/32

(52) U.S. Cl. CPC H01H 47/226; H01H 47/004; H01H 47/32

(57) ABSTRACT

A relay control circuit configured to control opening and closing of a contact of a non-latch relay, the non-latch relay including the contact and a coil configured to operate the contact, the relay control circuit comprises a high-voltage power supply; a low-voltage power supply; a power supply switching circuit; a first capacitor; and a reference voltage node, wherein the power supply switching circuit and one end of the first capacitor are connected to one end of the coil, the other end of the first capacitor and the reference voltage node are connected to the other end of the coil, and the power supply switching circuit is configured to switch a power supply connected to the one end. of the coil between the high-voltage power supply and the low-voltage power supply.

### CROSS-REFERENCE TO RELATED APPLICATION

The present application claims priority from Japanese Application JP2021-103538, the content of which is hereby incorporated by reference into this application.

### BACKGROUND

### 1. Field

The disclosure below relates to a relay control circuit and a power supply circuit.

Relays used in the power supply circuit are also required to have low loss. JP 2003-219314 A discloses a relay control circuit for low loss in the relay.

### SUMMARY

However, even with such a relay control circuit, there is still room for loss reduction of the relay. One aspect of the disclosure has an object to provide a relay control circuit capable of further reducing loss of the relay than in the related art.

In order to solve the problem described above, a relay control circuit according to one aspect of the disclosure is a relay control circuit configured to control opening and closing of a contact of a non-latch relay, the non-latch relay including the contact and a coil configured to operate the contact, the relay control circuit includes a high-voltage power supply, a low-voltage power supply, a power supply switching circuit, a first capacitor, and a reference voltage node, the power supply switching circuit and one end of the first capacitor are connected to one end of the coil, the other end of the first capacitor and the reference voltage node are connected to the other end of the coil, and the power supply switching circuit is configured to switch a power supply connected to the one end of the coil between the high-voltage power supply and the low-voltage tape power supply.

According to one aspect of the disclosure, low loss of the relay possible as compared to the related art.

### BRIEF DESCRIPTION OF THE DRAWINGS

FIG. 1 is a diagram illustrating a circuit configuration of a relay control circuit according to an embodiment of the disclosure.

FIG. 2 is a diagram showing an operation waveform of the relay control circuit according to the embodiment of the disclosure.

FIG. 3 is a diagram illustrating a configuration of a power supply circuit including the relay control circuit according to the embodiment of the disclosure.

### DESCRIPTION OF EMBODIMENTS

A relay including a contact functioning as a switch (switching part) is used in a power supply circuit. The relay control circuit opens and closes the contact by applying a voltage across the coil provided in the relay.

A non-latch relay used in the power supply circuit needs to continuously apply a voltage across the coil in order to hold a contact state (for example, pickup) during operation. A relay control circuit 10 of the disclosure reduces the loss of a relay RL1 by reducing the voltage to hold the pickup.

Another problem is that, the contact may drop out in a case where the voltage applied to the coil is drastically reduced. In order to reduce this risk, measures to moderate the voltage drop are also implemented in the relay control circuit 10 at the same time.

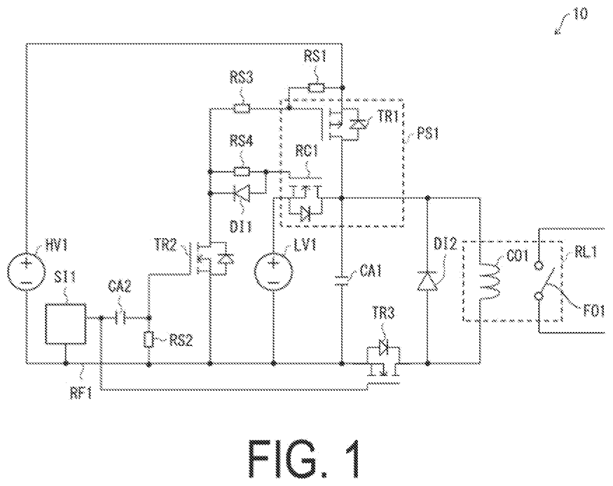

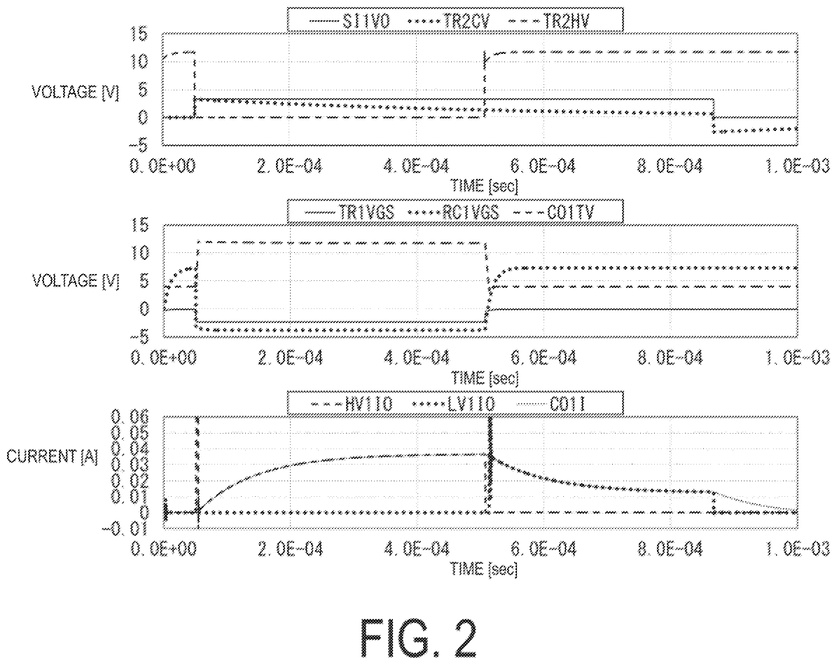

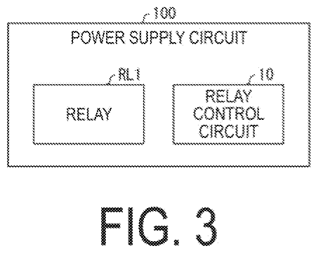

FIG. 1 is a diagram illustrating a circuit configuration of a relay control circuit 10 according to an embodiment of the disclosure. FIG. 2 is a diagram showing an operation waveform of each portion of the relay control circuit 10. FIG. 3 is a diagram illustrating a configuration of a power supply circuit 100 including the relay control circuit 10.

In the disclosure, for the sake of concise description, a “high-voltage power supply HV1” is also simply referred to as “HV1”, for example.

### Configuration of Relay RL1

As illustrated in FIG. 1, the relay control circuit 10 is connected to the relay RL1. The relay RL1 includes a contact FO1 and a coil CO1 for operating the contact FO1. The relay control circuit 10 controls opening and closing of the contact FO1 provided in RL1 by applying a voltage across the coil CO1 provided in the relay RL1. RL1 is a non-latch relay, and FO1 is a normally open contact. Thus, it is necessary to continuously apply the voltage across CO1 in order to continue closing (pickup) of FO1. CO1 is specified to have a rated voltage of 12V and a resistance of 320Ω.

### Definitions of Terms

Prior to describing the relay control circuit 10, each term is defined in the present specification as follows.

Transistor: An element including three terminals of a high-voltage terminal, a low-voltage terminal, and a control terminal described below. The voltage or current control of the control terminal can control a state in which a current flows from the high-voltage terminal to the low-voltage terminal and a state in which the current does not flow. A metal-oxide semiconductor field effect transistor (MOSFET) and a bipolar transistor also fall under this transistor.

In a case of an N-channel metal-oxide semiconductor (NMOS), a drain is the high-voltage terminal, a source is the low-voltage terminal, and a gate is the control terminal. In a case where a voltage between the gate and the source of the NMOS is equal to a threshold voltage or more, a current flows from the high-voltage terminal to the low-voltage terminal. In a case of a P-channel metal-oxide semiconductor (PMOS), the source is the high-voltage terminal, the drain is the low-voltage terminal, and the gate is the control terminal. In a case where the voltage between the gate and the source of the PMOS is equal to the threshold voltage or less, the current flows from the high-voltage terminal to the low-voltage terminal. In a case of PNP bipolar transistors, an emitter is the high-voltage terminal, a collector is the low-voltage terminal, and a base is the control terminal. In a case where a current flows to the control terminal of the PNP bipolar transistor, the current flows from the high-voltage terminal to the low-voltage terminal.

High-voltage terminal: Terminal used by applying a voltage higher than that of the low-voltage terminal.

Low-voltage terminal: Terminal used by applying a voltage lower than that of the high-voltage terminal.

Rectifying element: Element for causing a current to flow from an anode to a cathode represented by a diode. Here, synchronous rectifying elements represented by the NMOS and the PROS are also included. In the case of the NMOS, the source and the drain can be defined as the anode and the cathode, respectively. In the case of PMOS, the drain and the source can be defined as the anode and the cathode, respectively.

### Elements Constituting Relay Control Circuit 10

As illustrated in FIG. 1, the relay control circuit 10 according to the present embodiment includes HV1, LV1, TR1, TR2, TR3, RC1, RS1, RS2, RS3, RS4, CA1, CA2, PS1, RF1, DI1, DI2, and SI1. PS1 includes TR1 and RC1. In more detail, the relay control circuit 10 according to the present embodiment includes the following elements.

HV1 is a high-voltage power supply having a voltage of 12 V. LV1 is a low-voltage power supply having a voltage of 4 V. In HV1 and LV1, + side is a positive electrode, and − side is a negative electrode. TR1 is a first transistor, and is the PMOS in the present embodiment. For TR1, a threshold voltage is −1.55 V, an input capacitance is 25 pF, and an on resistance is 6Ω. RC1 is a rectifying element, and is the NMOS in the present embodiment. For RC1, the threshold voltage is 1.6 V, the input capacitance is 20 pF, and the on resistance is 1Ω. PS1 is a power supply switching circuit, and includes TR1 and RC1.

TR2 is a second transistor, and is the NMOS in the present embodiment. TR3 is a third transistor, and is the NMOS in the present embodiment. Each of TR2 and TR3 has the threshold voltage of 1.35 V, the input capacitance of 9 pF, and the on resistance of 2Ω.

Each of DI1 and DI2 is a diode having a forward voltage (VF) of 0.7 V. RS1 is a first resistor, and a resistance value is 20 kΩ. RS2 is a second resistor, and a resistance value is 510 kΩ. RE3 is a third resistor, and a resistance value is 82 kΩ. RS4 is a fourth resistor, and a resistance value is 470 kΩ. CA1 is a first capacitor having electrostatic capacitance of 27 nF. CA2 is a second capacitor having electrostatic capacitance of 1 nF. SI1 is a signal generator, and outputs 0 V and 3.3 V from a signal output terminal of SI1. RF1 is a reference voltage node (0 V).

In the relay control circuit 10, RS3 and RS4 are not essential to achieve the effect of the present embodiment. RS3 and RS4 are components that can be appropriately added to the relay control circuit 10 or can be appropriately deleted from the relay control circuit 10 according to characteristics of the first transistor TR1, the second transistor TR2, and the rectifying element RC1 included in the relay control circuit 10. If not required, direct wiring connection can be employed without using these components.

In the relay control circuit 10, DI1 and DI2 are also not essential to achieve the effect of the present embodiment. These connection destinations can also be arbitrarily changed.

### Main Circuit Portion of Relay Control Circuit 10

In order to picks up FO1 of RL1, it is necessary to apply a voltage of 7 V or more to CO1. In order to prevent dropout of FO1 and perform holding of the pickup, it is necessary to apply a voltage of 8 V or more to CO1. In the relay control circuit 10, 12 V of HV1 is used to perform the pickup, and 4 V of LV1 is used to hold the pickup.

PS1 connected to one end of CO1 is a circuit for switching a power supply for applying the voltage to one end of CO1 between HV1 and LV1. The high-voltage terminal of TR1 is connected to a positive electrode of HV1, and the low-voltage terminal of TR1 is connected to one end of CO1. The anode of RC1 is connected to a positive electrode of LV1, and the cathode of RC1 is connected to one end of CO1. One end of CA1 is connected to one end of CO1. A negative electrode of HV1, a negative electrode of LV1, and the other end of CA1 are connected to RF1. The other end of CO1 is connected to RF1 via TR3. In a case where TR3 is not necessary, the other end of CO1 can be connected to RF1 to operate the circuit.

The circuit operation by this connection causes TR1 to be turned ON to apply the voltage of 12 V to CO1 to perform the pickup of FO1. RC1 prevents a short circuit between HV1 and LV1 due to TR1 being turned on. Thereafter, by turning off TR1, an electromotive voltage of the CO1 causes RC1 to conduct. A voltage of 3.3 V obtained by subtracting 0.7 V of a forward voltage drop of RC1 from 4 V of LV1 is applied to CO1. Since the contact FO1 can be held with 3.3 V in this relay RL1, low loss of the relay RL1 can be performed while preventing the dropout of FO1.

CA1 is connected to one end of CO1 so as to suppress the dropout of the contact FO1 due to a rapid voltage drop after turning off TR1. CA1 makes a change in voltage at one end of CO1 gentle. The pickup of the contact FO1 by the high-voltage power supply HV1 is performed by PS1, and the contact FO1 can be held by the low-voltage power supply LV1 with low loss. Furthermore, the dropout of the contact FO1, which is a risk in a case where the power supply is changed, can be suppressed by slowing down the voltage change by the first capacitor CA1.

### Applicable Electrostatic Capacitance of First Capacitor CA1 and Current of Coil CO1

In the relay control circuit 10, the electrostatic capacitance of CA1 is in a range of 1 nF or more and 10 μF or less. The current from HV1 to CO1 is in a range of 0.001 A or more and 0.1 A or less. In a case where the electrostatic capacity of CA1 is 1 nF or more and the current to CO1 is 0.1 A or less, the voltage change at one end of CO1 in a case where the power supply is changed can be reduced to 0.1 V or less per 1 n second. Thus, the risk of the dropout of the contact FO1 in a case where the power supply is changed can be reduced. In a case where the electrostatic capacitance of CA1 is 10 μF or less and the current to CO1 is 0.001 A or more, the voltage change at one end of CO1 in a case where the power supply is changed can secure 100 nV or more per 1 n second. Thus, the relay RL1 can be controlled within a realistic time.

### ON/OFF Control Circuit of First Transistor TR1

In TR1 not connected to the reference voltage node RF1, ON/OFF switching is difficult with a signal voltage of 3.3 V/0 V. In the present embodiment, an improvement to facilitate ON/OFF switching of TR1 is incorporated into the relay control circuit 10. The high-voltage terminal of TR2 is connected to the control terminal of TR1. The low-voltage terminal of TR2 is connected to RF1. The control terminal of TR1 is connected to the positive electrode of the high-voltage power supply HV1 via RS1. Thus, in a case where the control terminal of TR1 is floating, TR1 is turned off. Whether the RS3 is applied can be selected according to the characteristics of each transistor. In these connections, in a case where TR2 is turned on, TR1 is also tuned on. in a case where TR2 is turned off, TR1 is also tuned off. The TR2 is connected to the reference voltage node RF1, and thus TR2 can be easily turned ON/OFF with 3.3 V/0 V, which are normal signal voltages.

Even in a case where TR1 is not, the PROS, TR1 similarly functions as long as TR1 is a transistor such as the PNP bipolar or the like similar to the PMOS. In a case of changing to TR1 having different characteristics, it is necessary to adjust the resistance value of RS1 and the resistance value of RS3.

### Synchronous Rectification ON/OFF Control Circuit of Rectifying Element RC1

The voltage drop 0.7 V from the anode to the cathode of RC1 can be reduced to 0.01 V by performing synchronous rectification ON (ON of the NMOS). The reduction in the voltage drop allows the voltage of LV1 to be lowered, thus enabling further low loss of relay RL1. In the present embodiment, an improvement to facilitate the synchronous rectification ON/OFF switching of the RC1 not connected to the reference voltage node RF1 is incorporated for performing the synchronous rectification.

The control terminal of RC1 is connected to the positive electrode of the high-voltage power supply HV1 via RS1, RS3, and RS4. The control terminal of RC1 is connected to the high-voltage terminal of TR2 via RS4. The control terminal of RC1 is further connected to one end of DI1, and the other end of DI1 is connected to the high-voltage terminal of TR2. That is, RS4 and DI1 are connected in parallel to the control terminal of RC1 and the high-voltage terminal of TR2. Whether RS3, RS4, and DI1 are applied to the relay control circuit 10 can be selected according to the characteristics of each element.

In these connections, in a case where TR2 is OFF, RC1 is turned on with the voltage of the high-voltage power supply HV1. In a case where TR2 is turned on, the voltage of the control terminal of RC1 is 0 V, which is lower than the voltage of the anode (4 V), and RC1 is turned off. The voltage of the control terminal is lower than the voltage of the anode, and thus false ON can be prevented. Thus, malfunction in which the high-voltage power supply HV1 and the low-voltage power supply LV1 are short circuited can be prevented.

### Dropout Control Circuit of Contact FO1

The dropout of FO1 can be performed by lowering the voltage of LV1. In the present embodiment, a circuit facilitating the performing of the dropout is incorporated into the relay control circuit 10. TR3 is disposed between the other end of the CO1 and RF1. A high-voltage terminal of TR3 is connected to the other end of the CO1, and a low-voltage terminal of TR3 is connected to RF1. By turning off this TR3, the voltage across CO1 is suppressed, and FO1 drops out.

### Circuit for Controlling Second Transistor TR2 and Third Transistor TR3 with the Same Signal

Each of TR2 and TR3 can be controlled by a different signal, but in this embodiment, a circuit capable of being controlled with the same signal is incorporated into the relay control circuit 10. The control terminal of TR3 is connected to the signal output terminal of SI1. The control terminal of TR2 is connected to the signal output terminal of SI1 via CA2, and is connected to RF1 via RS2. The 3.3 V signal of SI1 turns on TR3 to enable voltage application to CO1, and turns on TR2 to turn on TR1. In a case where TR1 is turned on, the voltage of HV1 can be applied to CO1, and thus the pickup of FO1 can be performed. Since the control terminal of TR2 is connected to RF1 via RS2, TR2 is turned off after a lapse of time. In a case where TR2 is turned off, TR1 is turned off and the synchronous rectification of RC1 turned on. Thus, a series of control from the pickup of FO1 to the contact holding with low loss can be performed by the single signal of SI1.

### Operation Waveform of Relay Control Circuit

The operation waveform of the relay control circuit 10 illustrated in FIG. 1 will be described below with reference to three graphs shown in FIG. 2. Each line of these graphs describe the following items.

SI1VO: Voltage of the output terminal of SI1

TR2CV: Voltage of the control terminal of TR2

TR2HV: Voltage of the high-voltage terminal of TR2

TR1VGS: Control terminal voltage with respect to the high-voltage terminal of TR1

RC1VGS: Control terminal voltage with resect to the low-voltage terminal of RC1

CO1TV: Voltage of one end of CO1

HV1IO: Output current of HV1

LV1IO: Output current of LV1

CO1I: Current of CO1

### First Step: Output 3.3 V of the Signal Generator SI1 Turns on TR3 and TR1, and Turns Off RC1

By setting SI1VO to 3.3 V, the control terminal of TR3 exceeds the threshold voltage. Thus, TR3 is turned on, and a voltage can be applied to the coil CO1. At the same time as TR3 is turned on, TR2CV exceeds the threshold voltage, and TR2HV is reduced to 0 V. TR2HV simultaneously affects TR1VGS and RC1VGS connected to TR2. TR1VGS is −3 V and TR1 is turned ON. RC1VGS is −4 V, and RC1 is turned off (OFF of the synchronous rectification). As illustrated in CO1TV, the voltage of HV1 is applied to CO1. As a result, CO1IO increases and FO1 is picked up.

### Second Step: OFF of TR1 and ON of RC1 Due to TR2CV Reduction after a Lapse of Time

TR2CV is below the threshold voltage after the lapse of time, and is turned off. Thus, TR1VGS is 0 V, and TR1 is turned off. RC1VGS is 8 V, and RC1 is turned on (ON of the synchronous rectification). As a result, CO1TV is switched to the voltage of LV1, and the pickup of the contact FO1 is held with low loss. CO1TV has a gradual fall in a case where CO1TV drops from 12 V to 4 V, and the risk of the dropout of the contact. FO1 is reduced.

### Third Step: Drops Out Contact FO1 with Output 0 V of Signal Generator ST1

TR3 is switched to OFF by setting SI1VO to 0 V. As a result, the other end of CO1 is clamped to 4V by the conduction of DI2. Thus, the voltage across CO1 drops, and FO1 drops out.

### Power Supply Device Provided with Relay Control Circuit

As illustrated in FIG. 3, the power supply circuit 100 includes the relay RL1 and the relay control circuit 10. In other words, the relay control circuit 10 constitutes the power supply circuit 100 together with RL1. In the power supply circuit 100, RL1 is used as a power supply input changeover switch. By using the relay control circuit 10, low loss of RL1 can be performed. Thus, loss in the power supply circuit 100 can be reduced.

FormA, which is a normally open is applied to FO1 of RL1. The relay control circuit 10 is also applicable to FormB and FormC according to the application, without being limited to FormA. Note that each numerical value described above is merely an example. In order to adjust the circuit operation, addition or resistors to the wiring lines or addition of capacitors between the wiring lines can be performed as appropriate.

### Supplementary Information

While there have been described what are at present considered to be certain embodiments of the invention, it will be understood that various modifications may be made thereto, and it is intended that the appended claims cover all such modifications as fail within the true spirit and scope of the invention.

What is claimed is:

1. A relay control circuit configured to control opening and closing of a contact of a non-latch relay, the non-latch relay including the contact and a coil configured to operate the contact, the relay control circuit comprising:
a high-voltage power supply;
a low-voltage power supply;
a power supply switching circuit;
first capacitor; and
a reference voltage node,
wherein the power supply switching circuit and one end of the first capacitor are connected to one end of the coil,
the other end of the first capacitor and the reference voltage node are connected to the other end of the coil, and
the power supply switching circuit is configured to switch a power supply connected to the one end of the coil between the high-voltage power supply and the low-voltage power supply.

2. The relay control circuit according to claim 1,
wherein electrostatic capacitance of the first capacitor is 1 nF or more and 10 μF or less, and
a current flowing from the high-voltage power supply to the coil is 0.001 A or more and 0.1 A or less.

3. The relay control circuit according to claim 1,
wherein the power supply switching circuit includes a first transistor and a rectifying element,
a high-voltage terminal of the first transistor is connected to a positive electrode of the high-voltage power supply,
a low-voltage terminal of the first transistor is connected to one end of the coil,
an anode of the rectifying element is connected to a positive electrode of the low-voltage power supply,
a cathode of the rectifying element is connected to one end of the coil, and
a negative electrode of the high-voltage power supply and a negative electrode of the low-voltage power supply are connected to the reference voltage node.

4. The relay control circuit according to claim 2,
wherein the power supply switching circuit includes a first transistor and a rectifying element,
a high-voltage terminal of the first transistor is connected to a positive electrode of the high-voltage power supply,
a low-voltage terminal of the first transistor is connected to one end of the coil,
an anode of the rectifying element is connected to a positive electrode of the low-voltage power supply,
a cathode of the rectifying element is connected to one end of the coil, and
a negative electrode of the high-voltage power supply and a negative electrode of the low-voltage power supply are connected to the reference voltage node.

5. The relay control circuit according to claim 3, further comprising:
a second transistor,
wherein a low-voltage terminal of the second transistor is connected to the reference voltage node,
a high-voltage terminal of the second transistor is connected to a control terminal of the first transistor,
a control terminal of the first transistor is connected to a positive electrode of the high-voltage power supply via a first resistor, and
in a case where the second transistor is turned on, the first transistor is turned on, and in a case where the second transistor is turned off, the first transistor is turned off.

6. The relay control circuit according to claim 4, further comprising:
a second transistor,
wherein low-voltage terminal of the second transistor is connected to the reference voltage node,
a high-voltage terminal of the second transistor is connected to a control terminal of the first transistor,
a control terminal of the first transistor is connected to a positive electrode of the high-voltage power supply via a first resistor, and
in a case where the second transistor is turned on, the first transistor is turned on, and in a case where the second transistor is turned off, the first transistor is turned off.

7. The relay control circuit according to claim 5,
wherein the rectifying element is an NMOS, and
control terminal of the NMOS is connected to the high-voltage terminal of the second transistor, so that a voltage or the control terminal of the NMOS is lower than a voltage of an anode of the NMOS in a case where the second transistor is turned on.

8. The relay control circuit according to claim 6,
wherein the rectifying element is an NMOS, and
a control terminal of the NMOS is connected to the high-voltage terminal of the second transistor, so that a voltage of the control terminal of the NMOS is lower than a voltage of an anode of the NMOS in a case where the second transistor is turned on.

9. The relay control circuit according to claim 7, further comprising:
a third transistor disposed between the other end of the coil and the reference voltage node,
wherein a high-voltage terminal of the third transistor is connected to the other end of the coil, and
a low-voltage terminal of the third transistor is connected to the reference voltage node.

10. The relay control circuit according to claim 8, further comprising:
a third transistor disposed between the other end of the coil and the reference voltage node,
wherein a high-voltage terminal of the third transistor I connected to the other end of the coil, and
a low-voltage terminal of the third transistor is connected to the reference voltage node.

11. The rely control circuit according to claim 9, further comprising:
a signal generator,
wherein a control terminal of the third transistor is connected to a signal output terminal of the signal generator,
a control terminal of the second transistor is connected to the signal output terminal of the signal generator via a second capacitor and is connected to the reference voltage node via a second resistor.

12. The relay control circuit according to claim 10, further comprising:
a signal generator,
wherein a control terminal of the third transistor is connected to a signal output terminal of the signal generator,
a control terminal of the second transistor is connected to the signal output terminal of the signal generator via a second capacitor and is connected to the reference voltage node via a second resistor.

13. A power supply circuit comprising:
the relay control circuit according to claim. 1.
